(19) United States
(12) Patent Application Publication
(10) Pub. No.: US 2013/0034403 A1
(43) Pub. Date: Feb. 7, 2013

(54) SCREW COMPONENT WITH A WATERPROOF STRUCTURE

(71) Applicant: Chang-Feng Lan, New Taipei City (TW)

(72) Inventor: Chang-Feng Lan, New Taipei City (TW)

(21) Appl. No.: 13/402,877

(22) Filed: Feb. 23, 2012

(30) Foreign Application Priority Data
Aug. 3, 2011 (TW) 100127531

(51) Int. Cl. F16B 35/00; F16J 15/02

(52) U.S. Cl. 411/371.1

(57) ABSTRACT

A screw component with waterproof structure includes a screw body and a resilient waterproof member. The screw body has a screw head and a thread portion. The thread portion is connected to a side of the screw head for being screwed into a screwing structure. The resilient waterproof member includes a resilient body and at least one waterproof structure. The resilient body surrounds the screw head, and the at least one waterproof structure is disposed around a periphery of the resilient body. A width of the at least one waterproof structure is increasing from a side close to the thread portion to a side far from the thread portion. The at least one waterproof structure seals a hole on a housing cooperatively with the resilient body when the screw body screws the housing onto the screwing structure.

### BACKGROUND OF THE INVENTION

1. Field of the Invention

The present invention relates to a screw component, and more particularly, to a screw component with a waterproof structure.

2. Description of the Prior Art

Recently, waterproof function has been a tide of electronic products. In design of screw components, waterproof plastic materials are smeared over a joint between a screw head and a thread portion for waterproof. When the aforesaid screw component is screwed into a screwing structure, the screw head of the screw component compresses the waterproof plastic materials cooperatively with a screwing surface of the screwing structure, such that the waterproof plastic materials are filled with a gap between the screw head and the screwing surface, so as to seal a screwing hole of the screwing structure. Accordingly, the waterproof function is achieved.

However, the aforesaid screw component with waterproof plastic materials is not reusable. Since plastic deformation of the waterproof plastic materials occurs when the screw component with waterproof plastic materials is unscrewed from the screwing structure, the waterproof plastic materials cannot seal the screwing hole completely when the aforesaid screw component is re-screwed on another screwing structure. Accordingly, it causes waste and increases cost when manufacturing the electronic products.

### SUMMARY OF THE INVENTION

Thus, the present invention provides a screw component with a waterproof structure for solving above drawbacks.

According to the claimed invention, a screw component for sealing a hole on a housing includes a screw body and a waterproof member. The screw body includes a screw head and a thread portion, and the thread portion is connected to a side of the screw head for being screwed into a screwing structure. The waterproof member includes a resilient body and at least one waterproof structure. The resilient body surrounds the screw head. The at least one waterproof structure is disposed around a periphery of the resilient body. A width of the at least one waterproof structure is increasing from a side close to the thread portion to a side far from the thread portion. The at least one waterproof structure seals the hole on the housing cooperatively with the resilient body when the screw body screws the housing onto the screwing structure.

According to the claimed invention, a slot is formed on a periphery of the screw head for containing the resilient body.

According to the claimed invention, the resilient body is disposed around a bottom of the screw head.

According to the claimed invention, the at least one waterproof structure seals the hole of the housing cooperatively with the resilient body in a tight fitting manner when the screw body screws the housing onto the screwing structure.

According to the claimed invention, the side far from the thread portion of the at least one waterproof structure is an inclined plane.

According to the claimed invention, a cross section of the at least one waterproof structure is substantially a triangular shape.

According to the claimed invention, the at least one waterproof structure includes a first waterproof structure and a second waterproof structure. A side close to the thread portion of the first waterproof structure is connected to a side far from the thread portion of the second waterproof structure.

According to the claimed invention, a size of the first waterproof structure is substantially identical to a size of the second waterproof structure.

In summary, when the screw component of the present invention screws the housing onto the screwing structure, the waterproof member surrounding the screw head of the screw component utilizes the resilient body to seal the hole on the housing cooperatively with the waterproof structures. Furthermore, since the resilient body and the waterproof structures of the waterproof member have elasticity, the waterproof member of the screw component can recover to an unscrewed status when the screw component is unscrewed from the housing and the screwing structure, such that the resilient body and the waterproof structure of the waterproof member is capable of sealing the hole on the housing again when the screw component of the present invention is re-screwed. Accordingly, the screw component of the present invention is reusable, so as to reduce cost in manufacture with the screw components of the present invention implemented into the electronic products.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a screw component according to an embodiment of the present invention.

FIG. 2 is an exploded diagram of the screw component according to the embodiment of the present invention.

FIG. 3 is a sectional view of the screw component according to the embodiment of the present invention.

FIG. 4 is a diagram illustrating part of the screw component in a first screwing configuration according to the embodiment of the present invention.

FIG. 5 is a diagram illustrating part of a screw component in the first screwing configuration according to another embodiment of the present invention.

FIG. 6 is a diagram illustrating part of the screw component in a second screwing configuration according to another embodiment of the present invention.

### DETAILED DESCRIPTION

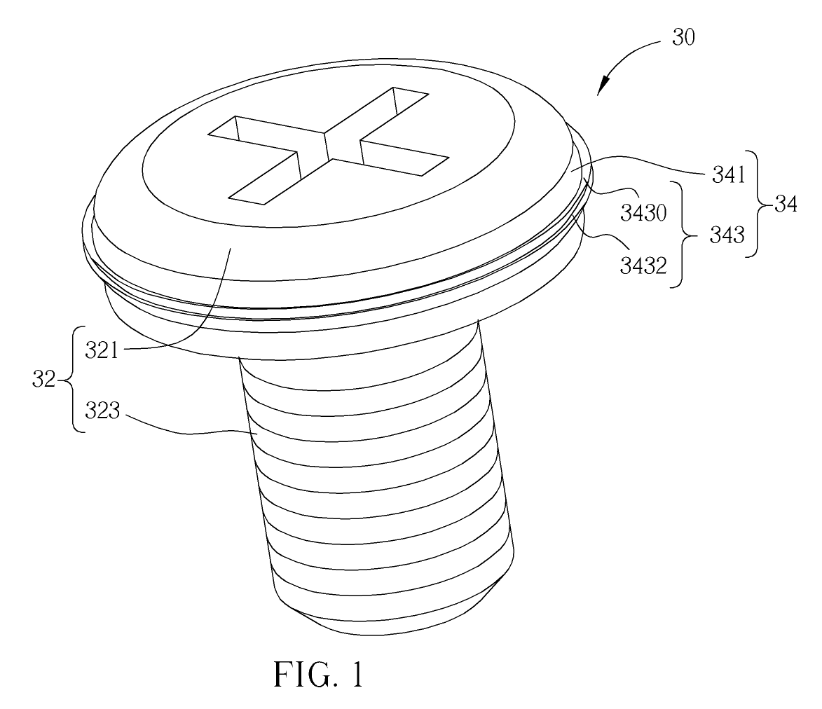

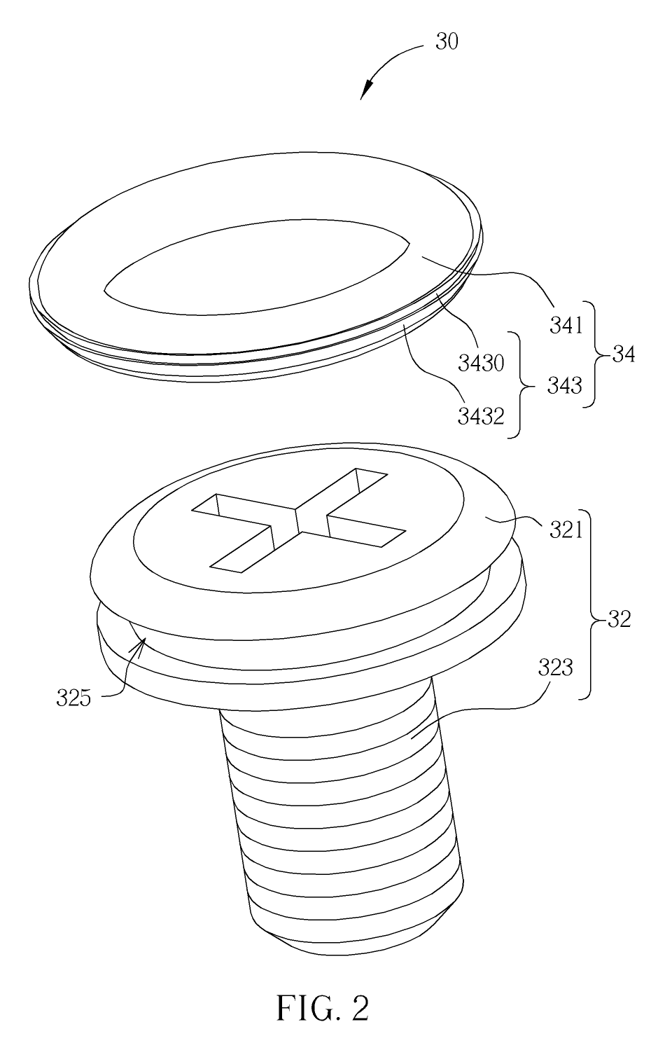

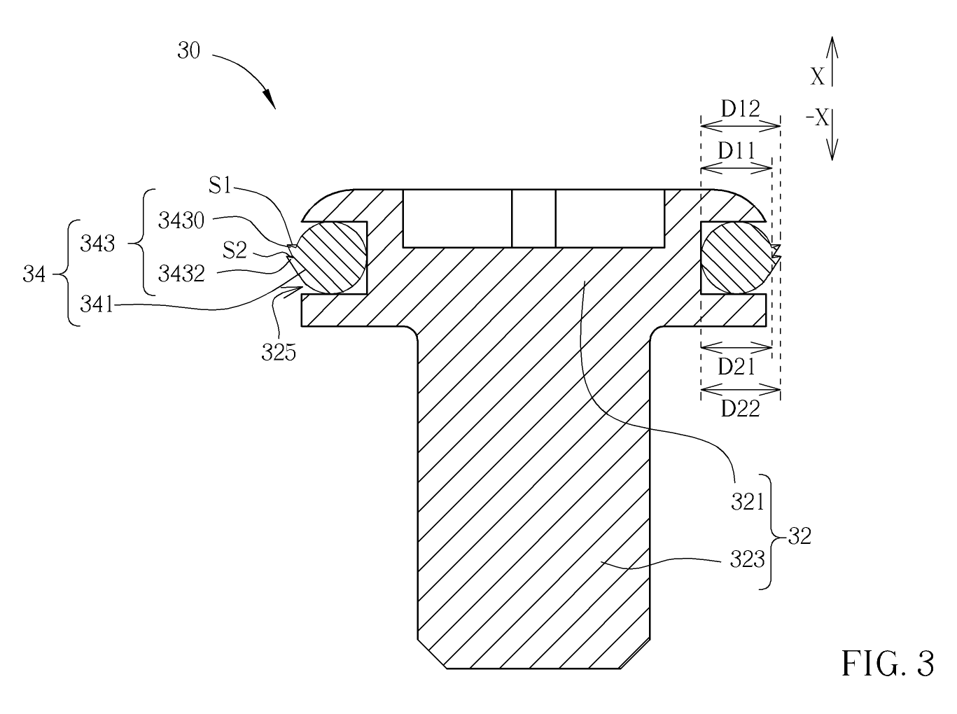

Please refer to FIG. 1. FIG. 1 is a diagram of a screw component 30 according to an embodiment of the present invention. As shown in FIG. 1, the screw component 30 includes a screw body 32 and a waterproof member 34. The screw body 32 includes a screw head 321 and a thread portion 323, and the thread portion 323 is connected to a side of the screw head 321. Please refer to FIG. 2 and FIG. 3. FIG. 2 is an exploded diagram of the screw component 30 according to the embodiment of the present invention. FIG. 3 is a sectional view of the screw component 30 according to the embodiment of the present invention. As shown in FIG. 2 and FIG. 3, the waterproof member 34 includes a resilient body 341 and at least one waterproof structure 343. The resilient body 341 surrounds the screw head 321. In this embodiment, the waterproof structure 343 includes a first waterproof structure 3430 and a second waterproof structure 3432. The first waterproof structure 3430 and the second waterproof structure 3432 are disposed around a periphery of the resilient body 341 for providing waterproof function, and the waterproof structure 343 can be made of flexible and stretchable materials. Furthermore, the waterproof member 34 can be made of materials with high-temperature endurance for meeting requirement of assembly process. In this embodiment, a slot 325 is formed on a periphery of the screw head 321 for containing the resilient body 341. In other words, the resilient body 341 of the waterproof member 34 is disposed in a position between a top of the screw head 321 and a bottom of the screw head 321. In addition, it should be noticed that an amount of the waterproof structures 343 of the waterproof member 34 is not limited to those mentioned in this embodiment, and it depends on practical demands.

Furthermore, a size of the first waterproof structure 3430 can be, but not limited to, substantially identical to a size of the second waterproof structure 3432. In other words, the size of the first waterproof structure 3430 can be different from the size of the second waterproof structure 3432, and it depends on practical demands. As shown in FIG. 3, a width of the first waterproof structure 3430 is increasing from a side close to the thread portion 323 of the screw body 32 to a side far from the thread portion 323 of the screw body 32. In other words, a width D11 of the side close to the thread portion 323 of the screw body 32 of the first waterproof structure 3430 is gradually increasing to a width D12 of the side far from the thread portion 323 of the screw body 32 of the first waterproof structure 3430 in a -X direction. Similarly, a width of the second waterproof structure 3432 is increasing from a side close to the thread portion 323 of the screw body 32 to a side far from the thread portion 323 of the screw body 32. In other words, a width D21 of the side close to the thread portion 323 of the screw body 32 of the second waterproof structure 3432 is gradually increasing to a width D22 of the side far from the thread portion 323 of the screw body 32 of the second waterproof structure 3432 in a X direction.

Furthermore, the side close to the thread portion 323 of the screw body 32 of the first waterproof structure 3430 can be connected to the side far from the thread portion 323 of the screw body 32 of the second waterproof structure 3432. In such a manner, the screw component 30 of the present invention can enhance waterproof ability by utilizing the first waterproof structure 3430 and the second waterproof structure 3432 to provide double protection, so as to enhance waterproof effect of the screw component 30.

In summary, the width of the waterproof structure 343 is gradually increasing from the side close to the thread portion 323 of the screw body 32 to the side far from the thread portion 323 of the screw body 32, e.g. in the X direction. In other words, the width of the waterproof structure 343 is in design of forward type which means the widths D12, D22 is decreasing to the widths D11, D21 along a screwing direction of the resilient body 341, e.g. in the -X direction opposite to the X direction. Accordingly, the screw body 32 does not cause interference when the screw body 32 is screwed into other structures.

In this embodiment, the side far from the thread portion 323 of the first waterproof structure 3430, e.g. the side which has the width D12, is an inclined plane. The side far from the thread portion 323 of the second waterproof structure 3432, e.g. the side which has the width D22, is an inclined plane as well. In other words, a cross section of the waterproof structure 343 is substantially a triangular shape, as shown in FIG. 3. In such a manner, the waterproof structure 343 can be more flexible, so as to enhance waterproof ability.

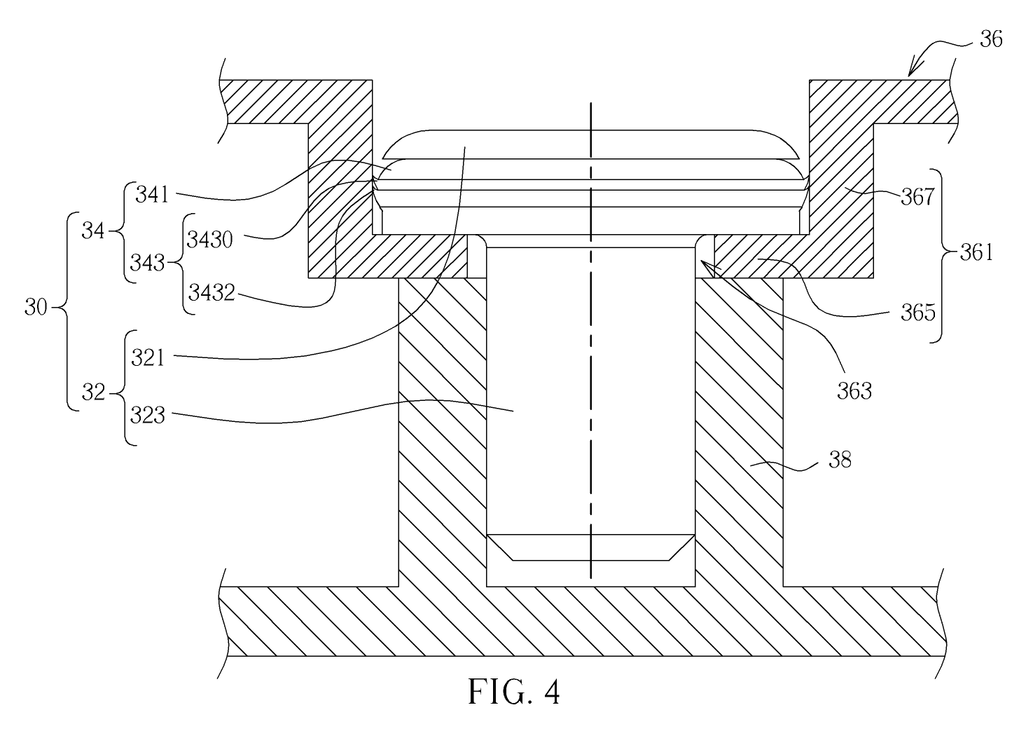

More detailed description for waterproof principle of the screw component 30 is provided as follows. Please refer to FIG. 4. FIG. 4 is a diagram illustrating part of the screw component 30 in a first screwing configuration according to the embodiment of the present invention. As shown in FIG. 4, the screw component 30 is used for screwing a housing 36 onto a screwing structure 38. The housing 36 has a recess 361, and the screw component 30 is disposed within the recess 361 for screwing the housing 36 onto the screwing structure 38. When the screw component 30 is used for screwing, the thread portion 323 of the screw body 32 can pass through a hole 363 on the housing 36 first and then be screwed into the screwing structure 38. By screwing of the thread portion 323 of the screw body 32 and the screwing structure 38, the screw head 321 can press a bottom 365 of the recess 361 of the housing 36 onto a top surface of the screwing structure 38 when the screw body 32 is screwed into the screwing structure 38. Furthermore, the widths of the first waterproof structure 3430 and the second waterproof structure 3432 can be decreasing along the screwing direction of the screw component 30. According to the design of forward type, the screw component 30 does not cause interference in process of screwing the housing 36 onto the screwing structure 38 by the screw component 30. Thus, the housing 36 can be screwed onto the screwing structure 38 by the screw body 32 of the screw component 30. In the meanwhile, the resilient body 341, the first waterproof structure 3430 and the second waterproof structure 3432 can attach a side wall 367 of the recess 361 in a tight fit manner. In such a manner, when the thread portion 323 of the screw body 32 screws the housing 36 onto the top surface of the screwing structure 38, the first waterproof structure 3430 and the second waterproof structure 3432 can seal the hole 363 on the housing 36 cooperatively with the resilient body 341, so as to achieve waterproof effect.

In addition, by design of the forward type and the inclined planes S1, S2, the first waterproof structure 3430 and the second waterproof structure 3432 can attach the side wall 367 of the recess 361 more tightly, so as to enhance waterproof effect of the screw component 30. On the other hand, since the waterproof member 34 has elasticity, the waterproof member 34 of the screw component 30 can recover to an unscrewed status when the screw component 30 is unscrewed from the recess 361 of the housing 36 and from the screwing structure 38, such that the resilient body 341 and the waterproof structure 343 of the waterproof member 34 is capable of sealing the hole 363 on the housing 36 again when the screw component 30 is re-screwed. Accordingly, the screw component 30 of the present invention is reusable, so as to reduce cost in manufacture with the screw components 30 of the present invention implemented into the electronic products.

It should be noticed that the housing 36, which the screw component 30 of the present invention screws, can be preferably an upper housing of an electronic device, such as a notebook computer, a mouse, a display device and so on, and the screwing structure 38 can be preferably a screw boss on a bottom housing of the electronic device. The application of the screw component 30 is not limited to those mentioned in this embodiment. For example, the screw component 30 can be adapted to screw housings of tooling machines. In other words, the screw component 30 of the present invention can be adapted to screw housings of devices or apparatuses according to practical demands.

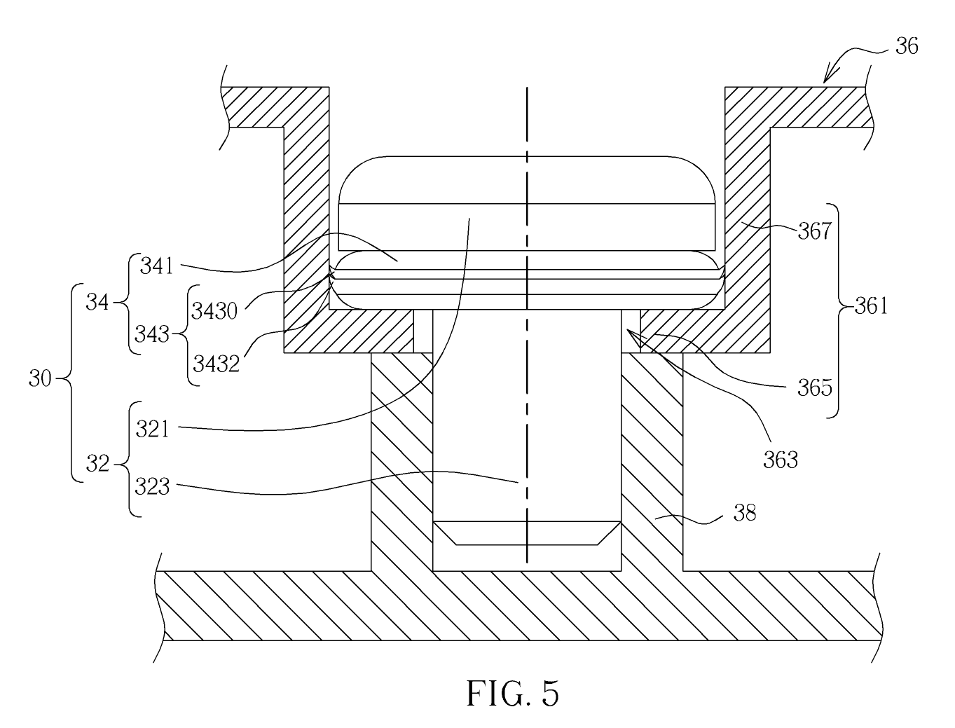

Please refer to FIG. 5. FIG. 5 is a diagram illustrating part of a screw component 30′ in the first screwing configuration according to another embodiment of the present invention. As shown in FIG. 5 and FIG. 4, main difference between the screw component 30′ and the aforesaid screw component 30 is that the resilient body 341 of the waterproof member 34 of the screw component 30′ is disposed around a bottom of the screw head 321 of the screw body 32. In other words, the slot 325 is omitted to dispose on the screw head 321 of the screw component 30′ and is not required for the resilient body 341 of the waterproof member 34 to be contained.

When the screw component 30′ is used for screwing, the thread portion 323 of the screw body 32 can pass through the hole 363 on the housing 36 first and then be screwed into the screwing structure 38. By screwing of the thread portion 323 of the screw body 32 and the screwing structure 38, the resilient body 341 disposed around the bottom of the screw head 321 can press the bottom 365 of the recess 361 of the housing 36 onto the top surface of the screwing structure 38 when the screw body 32 is screwed into the screwing structure 38. Thus, the housing 36 can be screwed onto the screwing structure 38 by the screw body 32 of the screw component 30′. In the meanwhile, the resilient body 341, the first waterproof structure 3430 and the second waterproof structure 3432 can respectively attach the bottom 365 and the side wall 367 of the recess 361 in a tight fit manner. In such a manner, when the thread portion 323 of the screw body 32 screws the housing 36 onto the top surface of the screwing structure 38, the first waterproof structure 3430 and the second waterproof structure 3432 can seal the hole 363 on the housing 36 cooperatively with the resilient body 341, so as to achieve waterproof effect. It should be noticed that the components with the same denotes in FIG. 5 and FIG. 4 have the same structures and functions, so detailed description is omitted herein for simplicity.

In addition, in the aforesaid first screwing configuration, since the cross sections of the first waterproof structure 3430 and the second waterproof structure 3432 are triangular shapes, the first waterproof structure 3430 and the second waterproof structure 3432 are more flexible to endure larger deformation. In other words, the waterproof structure 343 of the present invention can attach the side wall 367 of the recess 361 by a larger area due to large deformation of the first waterproof structure 3430 and the second waterproof structure 3432. In other words, by the structures of the present invention, the first waterproof structure 3430 and the second waterproof structure 3432 can increase contact area for sealing the gap, so as to achieve better waterproof effect. In addition, according to the aforesaid structures, the first waterproof structure 3430 and the second waterproof structure 3432 can prevent twist, generated by inadequate deformation and resulting in gap between the waterproof structure 343 and the side wall 367 of the recess 361 so as to affect waterproof function, when screwing due to endurance of larger deformation.

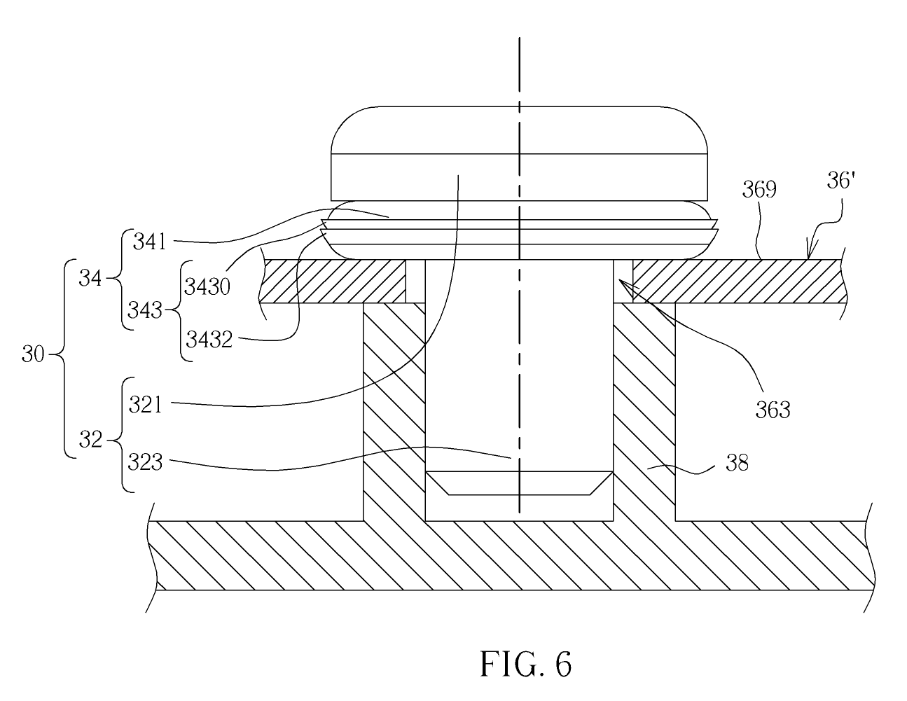

Please refer to FIG. 6. FIG. 6 is a diagram illustrating part of the screw component 30′ in a second screwing configuration according to another embodiment of the present invention. As shown in FIG. 6 and FIG. 5, main difference between the second screwing configuration and the aforesaid first screwing configuration is that the housing 36′ does not have the recess 361. When the screw component 30′ is used for screwing, the thread portion 323 of the screw body 32 can pass through the hole 363 on the housing 36 first and then be screwed into the screwing structure 38. By screwing of the thread portion 323 of the screw body 32 and the screwing structure 38, the screw head 321 can press a top surface 369 of the housing 36′ onto the top surface of the screwing structure 38 when the screw body 32 is screwed into the screwing structure 38. Thus, the housing 36′ can be screwed onto the screwing structure 38 by the screw body 32 of the screw component 30′. In such a manner, when the thread portion 323 of the screw body 32 screws the housing 36′ onto the top surface of the screwing structure 38, the resilient body 341 can seal the hole 363 on the housing 36′, so as to achieve waterproof effect. It should be noticed that the components with the same denotes in FIG. 6 and FIG. 5 has the same structures and functions, so detailed description is omitted herein for simplicity.

Compared to the prior art, when the screw component of the present invention screws the housing onto the screwing structure, the waterproof member surrounding the screw head of the screw component utilizes the resilient body to seal the hole on the housing cooperatively with the waterproof structures. Furthermore, since the resilient body and the waterproof structures of the waterproof member have elasticity, the waterproof member of the screw component can recover to an unscrewed status when the screw component is unscrewed from the housing and the screwing structure, such that the resilient body and the waterproof structure of the waterproof member is capable of sealing the hole on the housing again when the screw component of the present invention is re-screwed. Accordingly, the screw component of the present invention is reusable, so as to reduce cost in manufacture with the screw components of the present invention implemented into the electronic products.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A screw component for sealing a hole on a housing, comprising:
a screw body comprising a screw head and a thread portion, the thread portion being connected to a side of the screw head for being screwed into a screwing structure; and
a waterproof member, comprising:
a resilient body surrounding the screw head, and
at least one waterproof structure disposed around a periphery of the resilient body, a width of the at least one waterproof structure being increasing from a side close to the thread portion to a side far from the thread portion, the at least one waterproof structure sealing the hole on the housing cooperatively with the resilient body when the screw body screws the housing onto the screwing structure.

2. The screw component of claim 1, wherein a slot is formed on a periphery of the screw head for containing the resilient body.

3. The screw component of claim 1, wherein the resilient body is disposed around a bottom of the screw head.

4. The screw component of claim 1, wherein the at least one waterproof structure seals the hole on the housing cooperatively with the resilient body in a tight fitting manner when the screw body screws the housing onto the screwing structure.

5. The screw component of claim 4, wherein the side far from the thread portion of the at least one waterproof structure is an inclined plane.

6. The screw component of claim 1, wherein a cross section of the at least one waterproof structure is substantially a triangular shape.

7. The screw component of claim 1, wherein the at least one waterproof structure comprises a first waterproof structure and a second waterproof structure, a side close to the thread portion of the first waterproof structure is connected to a side far from the thread portion of the second waterproof structure.

8. The screw component of claim 7, wherein a size of the first waterproof structure is substantially identical to a size of the second waterproof structure.
